(19) United States
(12) Patent Application Publication
(10) Pub. No.: US 2012/0226485 A1
(43) Pub. Date: Sep. 6, 2012

(54) METHODS FOR PREDICTING THE FORMATION OF WIND TURBINE BLADE ICE

(75) Inventors: Alexander Creagh, Bragg Creek (CA); Dustin Carlson, Dodge City, KS (US); Jeffrey McIntyre, Oklahoma City, OK (US); Timothy Tompkins, Dodge City, KS (US); Tim Hall, Dodge City, KS (US); Craig Dohrmann, Dodge City, KS (US); Travis Simmons, Dodge City, KS (US); Brent Haxton, Tuttle, OK (US); Miguel Gonzalez, Jupiter, FL (US); Van R. Culver, Pleasanton, CA (US); George Quiroga, Boynton Beach, FL (US); Ann Marie Frey, Port Saint Lucie, FL (US)

(73) Assignee: Inventus Holdings, LLC, Juno Beach, FL (US)

(21) Appl. No.: 13/039,846

(22) Filed: Mar. 3, 2011

(51) Int. Cl. G06G 7/48

(52) U.S. Cl. 703/7

(57) ABSTRACT

Models for predicting ice formation and/or accumulation on wind turbine blades and methods of their use in optimizing performance of wind turbines in the presence of adverse local weather conditions are disclosed. In certain embodiments, the predictive models include historical data of local meteorological conditions including, inter alia, wind speed, temperature, and relative humidity conditions and are useful, inter alia, for preemptively managing performance of wind turbines operation/shutdown cycles in response to a future predicted blade icing event based on a model of the present invention.

### FIELD OF THE INVENTION

The present invention relates to wind turbines and, more particularly, to ice formation and/or accumulation (icing) on the blades of wind turbines. The present invention also relates to models for predicting ice formation and/or accumulation on wind turbine blades and methods of their use in optimizing performance of wind turbines in the presence of adverse local weather conditions. In certain embodiments, the predictive models include historical data of local meteorological conditions including, inter alia, wind speed, temperature, and relative humidity conditions and are useful, inter alia, for preemptively managing performance of wind turbines operation/shutdown cycles in response to a future predicted blade icing event based on a model of the present invention.

### BACKGROUND OF THE INVENTION

Recently, wind turbines have received increased attention as an environmentally safe and relatively inexpensive alternative energy source. With this growing interest, considerable efforts have been made to develop wind turbines that are reliable and efficient.

Generally, a wind turbine includes a rotor having multiple blades. The rotor is mounted within a housing or nacelle, which is positioned on top of a truss or tubular tower. Utility grade wind turbines (i.e., wind turbines designed to provide electrical power to a utility grid) can have large rotors (e.g., 30 or more meters in diameter). Blades on these rotors transform wind energy into a rotational torque or force that drives one or more generators, rotationally coupled to the rotor through a gearbox. The gearbox steps up the inherently low rotational speed of the turbine rotor for the generator to efficiently convert mechanical energy to electrical energy, which is fed into a utility grid.

As interest in wind turbine power production and availability has increased, the search for suitable locations having winds that can provide sustainable cost effective energy has expanded, including areas where meteorological conditions are at times favorable to ice formation on wind turbine blades. The presence of suitable winds does not necessarily lead to cost effective power generation. Adverse impact on turbine power production efficiency may be caused by any number of factors. For example, ice formation on turbine blades can contribute to loss of efficiency through deterioration of the aerodynamic properties of the turbine blades. At times, icing may be so severe as to prevent turbines from producing power despite the presence of ideal wind conditions.

Icing may be divided into two forms, symmetric (icing on all blades) and asymmetric, (icing on some blades). Ice buildup typically occurs on the leading edge of the airfoil and causes a reduced lifting capability. Asymmetric icing increases wind turbine tower vibration, and increases lateral tower acceleration. Asymmetric icing may also yield a rotor-mass imbalance leading to higher fatigue loads, and thus requiring more robust and expensive wind turbine components and/or more frequent maintenance.

As the ice layer on the turbine blade becomes increasingly thick, weight is added to the airfoil so that the lifting airfoil surface becomes modified. For wind turbines, this modification can result in diminished aerodynamic rotor blade performance. This reduced performance can directly result in increased system loads and/or lost power output as well as higher stresses on several turbine components, including the blades and drive train.

As a consequence, efforts have been directed to improving the efficiency of wind turbines by systems and/or methods that detect the presence of ice on turbine blades.

For example, Ormel et al. (U.S. Pat. No. 7,487,673) disclose certain methods that reportedly detect ice, wherein the methods include providing an ice condition threshold parameter adapted for distinguishing a condition during which icing may occur and a condition during which icing may not occur, measuring a wind velocity with a first anemometer, wherein the first anemometer being of a first type, measuring a wind velocity with a second anemometer, wherein the second anemometer being of a second type, and wherein the second type is different from the first type, evaluating, for a condition during which icing may occur, a deviation of the wind velocity measured with the first anemometer and the wind velocity measured with the second anemometer, and determine whether the deviation exceeds a limit value based on a calibration conducted under a condition during which icing may not occur.

Thisted (U.S. Pat. No. 6,890,152) discloses certain methods for deicing a wind turbine blade including detecting an icy condition on a wind turbine blade and causing at least a portion of the wind turbine blade to vibrate, causing the ice built up on the wind turbine blade to break off.

Le Mieux (U.S. Pat. No. 7,086,834) discloses certain methods for detecting ice on a wind turbine having a rotor and one or more rotor blades each having blade roots includes monitoring meteorological conditions relating to icing conditions and monitoring one or more physical characteristics of the wind turbine in operation that vary in accordance with at least one of the mass of the one or more rotor blades or a mass imbalance between the rotor blades.

Sundermann et al. (U.S. Pat. No. 7,708,524) discloses certain methods and systems for detecting asymmetric utilizing lateral tower acceleration data may include: providing a lateral tower acceleration monitoring system; determining from the lateral tower acceleration monitoring system whether a lateral tower acceleration is above an acceleration limit; determining whether a rotor-mass imbalance condition exists; and determining whether the lateral tower acceleration coincides with icing on a rotor.

Myhr (U.S. Patent Application Publication No. 2010/0119370) discloses certain systems for detecting the presence of snow/ice on a wind turbine using ultrasound sensors and a system for de-icing wind turbines in which when the removal of snow/ice is detected, the heaters are switched off.

Scholte-Wassink (US Patent Application Publication 2010/0135787 A1) discloses certain methods of operating a wind turbine having a rotor with at least one blade, including methods of sensing an icing hazard for the blade; and moving the at least one blade into a position to reduce the icing hazard.

Wobben (US Patent Application Publication 2007/0154310 A1) is said to disclose certain methods of adapting the operation of wind turbines to changes in detected parameter values such as ice-created aerodynamic profile changes to rotor blades and reported alterations in generated output as a consequence of such parameter deviations.

Ahmann (US Patent Application Publication 2010/0143127 A1) discloses certain methods and systems for detecting icing on at least one wind turbine blade. An embodiment of the disclosed invention reportedly takes the form of a software application and process that utilizes the measured wind speed to detect icing on at least one wind turbine blade.

According to an abstract of the invention, Girardin (WO 2008/046215) discloses systems for controlling a wind turbine, comprising meteorological instruments for measuring ambient climatic conditions and subsequently generating meteorological signals, a memory for storing an icing tolerance, a first calculator for calculating a global icing probability from the meteorological signals and a controller to stop the wind turbine when the global icing probability is greater than the icing tolerance. The invention further relates to a method for controlling a wind turbine, comprising the following steps: a) measuring ambient climatic conditions and subsequently generating meteorological signals, b) storing an icing tolerance in memory, c) calculating a global icing probability from the meteorological signals and d) stopping the wind turbine when the global icing probability is greater than the icing tolerance.

Other methods of mitigating ice formation on wind turbine blades include painting the blades with a silicon containing compound or heating the individual blades, However, These types of mitigation are cost ineffective on the large scales necessary for wind farm energy production. Pausing a turbine to allow for ice removal is a more reasonable alternative, but costs associated with loss in power production and/or regulatory reporting for down time must be considered and balanced against maintenance costs and reduced lifetime of the turbine.

However, in many circumstances, the only reasonable prior art alternative for deicing wind turbine blades is sunlight and time, which may take days and accumulate significant losses in revenue from lost energy production.

There is still an unfulfilled need for algorithms, regression functions, models employing the algorithms or regression functions, and/or systems employing the regression functions that may be used in methods to better predict icing on wind turbine rotor blades, especially those methods that may predict the potential for icing prior to its formation so that proactive steps may be taken to minimize actual icing or any one or more of its adverse affects on the wind turbines that could occur without such proactive steps. Predictive methods that better limit the amount of turbine pausing necessary to avoid or reduce icing formation and/or its impact are also needed. The present invention is directed to these, as well as other important ends.

### SUMMARY OF THE INVENTION

In one embodiment, the invention is directed to wind turbine blade ice prediction models employing a logistic regression function, said function comprising a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time; and
said regression function for determining a probability that icing will occur under a particular set of wind speed, temperature and relative humidity conditions.

In another embodiment, the invention is directed to methods of predicting the probability of ice formation on one or more wind turbine blades, comprising:

(a) applying an ice prediction model employing a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time;
said regression function for determining a probability that icing will occur under a particular set of wind speed, temperature and relative humidity conditions;

(b) collecting second input data for one or more second wind turbines, each second input data comprising one or more second input data sets; each second data set taken at a different point in real time; each data set comprising input measurements of wind speed, temperature, and relative humidity conditions, each input measured in proximity to a second wind turbine; and

(c) calculating a probability as to whether, subsequent to the real time measurements, ice will form on one or more blades of the one or more second wind turbines.

In another embodiment, the invention is directed to methods of predicting the output or operation of a wind turbine at a wind farm site considered for new construction or acquisition, comprising:
(a) applying an ice prediction model employing a logistic regression function, said function comprising input data of at least one first wind turbine;
   said input data including two or more data sets from each of the at least one first wind turbines; each data set taken at a different point in time; each data set comprising input measurements of wind speed, temperature, and relative humidity conditions, each input being measured in proximity to the at least one first wind turbine;
   said input data for each data set further including an indication as to whether ice was present or absent on one or more blades of the at least one first wind turbine at said point in time;
   said regression function for determining a probability that icing will occur under a particular set of wind speed, temperature and relative humidity conditions;
(b) collecting historical weather condition data from one or more weather monitoring stations in proximity to the wind farm site considered for new construction or acquisition, each historical weather condition input data comprising one or more second input data sets; each second data set taken at a different point in recorded time; each data set comprising input measurements of wind speed, temperature, and relative humidity conditions, each input measured in proximity to the wind farm site considered for new construction or acquisition; and
(c) calculating a probability as to whether, subsequent to the recorded time measurements, ice would have formed on one or more blades of a second wind turbine;
(d) calculating the duration of an ice event based on the probability that ice would have formed on one or more blades of the second wind turbine; and
(e) estimating loss of output from the second wind turbine based on the duration of the ice event.

### BRIEF DESCRIPTION OF THE DRAWINGS

FIG. 1 represents a process flow diagram for FPDC (Remote Control Center) directed to initiation of a Blade Ice Mitigation process upon receipt of an icing alert through the installed and functional monitoring system employing a preferred prediction model of the present invention.

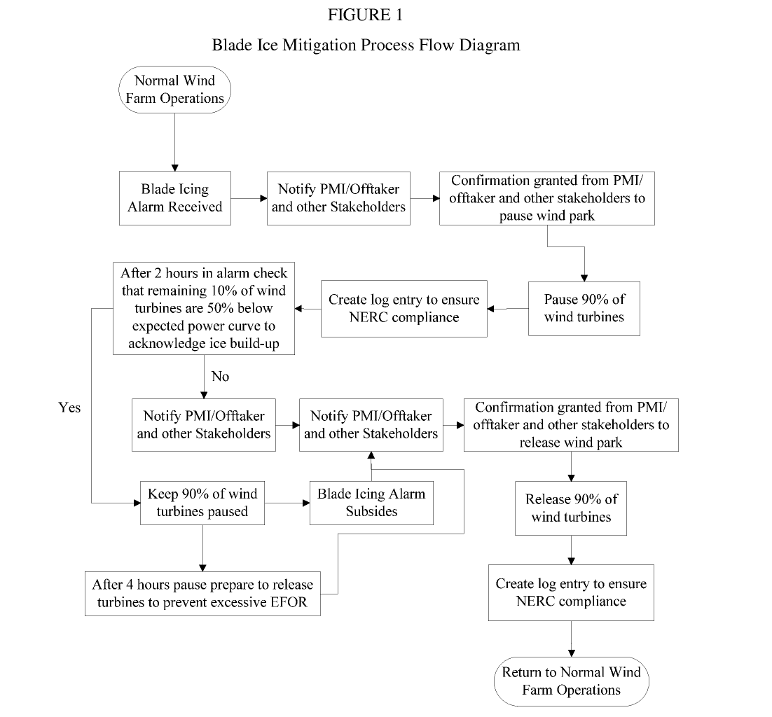

FIG. 2 shows an icing event wherein a preferred icing prediction model was employed to predict the probability of an icing event occurring in real time. The figure demonstrates the benefits of certain blade icing model and mitigation strategies based on a preferred embodiment of a regression model of the present invention. Test turbines were paused for 4 Hrs to avoid the icing event, upon return to service they had no ice accretion and provided nearly 170K of addition generation in contrast to control turbines that remained iced for 45 hrs. When the probability as calculated by the model equaled or exceeded the predetermined threshold value, test turbines were paused while the remaining non-test turbines were allowed to continue operating. The non-test turbines being monitored later tripped offline. The test turbines were later “unpaused” when the model predicted that the threat of ice accretion was substantially over. The test turbines are graphically shown as being back on line sooner than the non-test turbines and their extent of downtime was significantly shorter than downtime for non-test turbines, leading to enhanced overall efficiency and/or profitability for the test turbines.

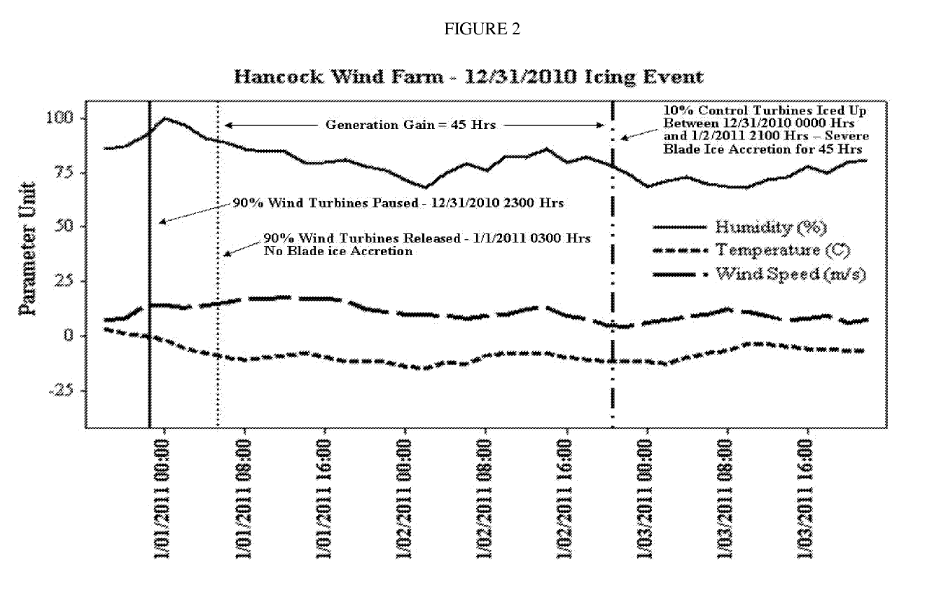

FIG. 3 shows a Weather EFOR (Equivalent Forced Outage Rate (measure of a unit's electrical generating plant unreliability) Process Flow Chart for a preferred model of the present invention and depicts an alternate use of the icing model for forecasting severe weather conditions at wind farm sites considered for new construction or acquisition, for example. This model use enables the user to help predict, inter alia, output and operation of wind farms within cold climate regions based on historical data as well as what types of weather conditions may affect the operation of the wind farm sites being assessed.

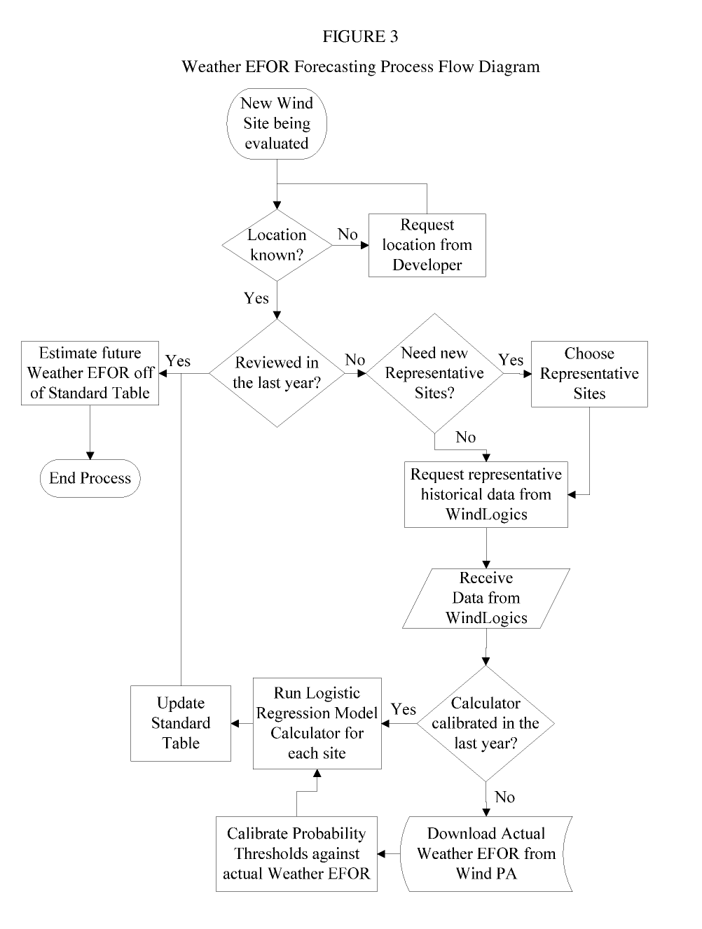

### DETAILED DESCRIPTION OF ILLUSTRATIVE EMBODIMENTS

The present invention relates, in part, to wind turbines and, more particularly, to ice formation and/or accumulation (icing) on the blades of wind turbines. The present invention also relates, in part, to logistic regression models that are useful for predicting ice formation and/or accumulation on wind turbine blades and methods of their use in optimizing performance of wind turbines in the presence of adverse local weather conditions. The invention is also directed in some aspects to the reduction and/or prevention of ice accretion on wind turbine blades, preferably in proactive response to predictions of a future icing event, preferably within hours, more preferably within one hour. Model predictions are based, at least in part, on logistic regression models for predicting ice formation and/or accumulation on wind turbine blades in view of current weather conditions such as wind speed, % relative humidity and temperature, preferably wherein the measurement of such weather conditions is recorded in proximity to a wind turbine where the icing event may occur.

As employed above and throughout the disclosure, the following terms, unless otherwise indicated, shall be understood to have the following meanings.

As used herein, the term “icing” refers to the presence of ice on a wind turbine blade in any solid form. For example, the ice may appear as “rime” or crystalline or highly structured ice or as a glaze or sheet of solid ice. Rime typically forms under low wind speed conditions, (e.g., <about 5 meters/sec) and may, be envisaged as, inter alia, a freezing fog. Due at least in part to its crystalline nature, it tends to fracture easily and is more readily removed from turbine blades than glazed ice. As rime builds up on blades, it may turn into “glaze” ice, increasing the time, effort and weather conditions required for its effective removal. In contrast to rime, glaze ice may be viewed as similar to the ice found in a skating rink, i.e., of a more concrete nature. In addition to its indirect formation (via rime) glaze ice may also form directly on turbine blades when weather conditions appropriate to its formation are present at the turbine's locale. Its physical characteristics make its removal from turbine blades, once formed, much more difficult and time consuming leading, to more significant levels of downtime and/or lowered power efficiency for turbines.

As used herein, “tripping offline” refers to the point in time that a running (non-paused) turbine stops running because of excessive ice build up on its blades. Reference to the tripped turbine coming “back online”, as used herein, refers to the point in time when the ice has melted, which can sometimes be as long as 3 to 5 days, and the turbine restarts.

In certain embodiments, the ice prediction models comprise:

a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time; and
said regression function for determining a probability that icing will occur under a particular set of wind speed, temperature and relative humidity conditions.

In other embodiments, the invention is directed to methods of predicting the probability of ice formation on one or more wind turbine blades, comprising:
(a) applying an ice prediction model employing a logistic regression function, said function comprising input data of at least one first wind turbine;
   said input data including two or more data sets from each of the at least one first wind turbines; each data set taken at a different point in time; each data set comprising input measurements of wind speed, temperature, and relative humidity conditions, each input being measured in proximity to the at least one first wind turbine;
   said input data for each data set further including an indication as to whether ice was present or absent on one or more blades of the at least one first wind turbine at said point in time;
   said regression function for determining a probability that icing will occur under a particular set of wind speed, temperature and relative humidity conditions;
(b) collecting second input data for one or more second wind turbines, each second input data comprising one or more second input data sets; each second data set taken at a different point in real time; each data set comprising input measurements of wind speed, temperature, and relative humidity conditions, each input measured in proximity to a second wind turbine; and
(c) calculating a probability as to whether, subsequent to the real time measurements, ice will form on one or more blades of the second wind turbine.

In some other embodiments, the invention is directed to methods of predicting the output or operation of a wind turbine at a wind farm site considered for new construction or acquisition, comprising:
(a) applying an ice prediction model employing a logistic regression function, said function comprising input data of at least one first wind turbine;
   said input data including two or more data sets from each of the at least one first wind turbines; each data set taken at a different point in time; each data set comprising input measurements of wind speed, temperature, and relative humidity conditions, each input being measured in proximity to the at least one first wind turbine;
   said input data for each data set further including an indication as to whether ice was present or absent on one or more blades of the at least one first wind turbine at said point in time;
   said regression function for determining a probability that icing will occur under a particular set of wind speed, temperature and relative humidity conditions;
(b) collecting historical weather condition data from one or more weather monitoring stations in proximity to the wind farm site considered for new construction or acquisition, each historical weather condition input data comprising one or more second input data sets; each second data set taken at a different point in recorded time; each data set comprising input measurements of wind speed, temperature, and relative humidity conditions, each input measured in proximity to the wind farm site considered for new construction or acquisition; and
(c) calculating a probability as to whether, subsequent to the recorded time measurements, ice would have formed on one or more blades of a second wind turbine;
(d) calculating the duration of an ice event based on the probability that ice would have formed on one or more blades of the second wind turbine; and
(e) estimating loss of output from the second wind turbine based on the duration of the ice event.

In certain preferred embodiments of the ice prediction models or methods of their use comprise: regression models, preferably logistic regression models, wherein the models are based on data collected pertaining to actual icing events and non-events.

The data collected from such actual events and/or non-events include measurement of one or more weather conditions taken in the proximity of the event or non-event over a period of time. While it is contemplated that data points taken at several discrete times may be combined in some manner, such as by averaging, it is preferred that the data taken at any one point in time at a particular location represent a data set. In certain preferred embodiments, the measured weather conditions include temperature, wind speed and/or % relative humidity, and may also include such other weather parameters such as barometric pressure, prevailing wind direction and/or elevation or any combination thereof. As used herein, the “term proximity of the event or non-event” with regard to an icing or non-icing event refers to such weather data as was recorded locally, such as at a local NOAA facility, airport monitoring system, or the like. More preferably it refers to measurements taken by sensor, and especially sensors attached to the wind turbine, the supporting tower for the turbine and/or at or near ground level, preferably within the wind turbine site where the event has occurred. In certain preferred embodiments, the sensors transmit the measured weather condition data to a computer containing the ice prediction model of the present invention.

In certain preferred embodiments, icing events are identified based on a turbine's actual power output deviation from its theoretical power curve output under local weather conditions, such as wind speed. Once identified, data sets generated for up to about three days prior to, during, and/or up to about three days after the icing event may also be reviewed and their actual and theoretical power outputs may be compared to better identify and/or pinpoint the initiation of the icing event, its duration. Numerical values can then be assigned to each data set indicating the presence or absence of ice. These data sets may then be incorporated into a revised model with improved reliability and/or predictability.

In some preferred embodiments, the prediction model input data further comprises wind turbine rotor speed.

In other preferred embodiments, the prediction model input data further comprises wind turbine blade dimensions, preferably including, for example, blade pitch.

Each data set also contains a numerical indication of whether icing did or did not occur during the event at the time the measurement of weather conditions was made, preferably wherein the presence of ice on the one or more blades of the at least one first wind turbine at said point in time in each prediction model data set is given a numerical value of 1 and the absence of ice is given a numerical value of 0.

Whether icing did or did not occur may be established by direct observation or by consideration of any number of output parameters from the wind turbine that are routinely monitored. For example, the theoretical output of a wind turbine may be calculated as a function of local wind speed and the known power curve for the turbine. The calculated (i.e., theoretical) output may be compared to actual measurement of output for the wind turbine. It is well known that icing reduces the efficiency of power generation for a turbine. Actual outputs that are lower than predicted outputs may be attributed to an icing event, the severity of which may be further estimated by the extent and/or duration of deviation of power output from the power curve prediction. Reviewing data sets taken at intervals of time over a range of time spanning from about 3 days prior to the event to about 3 days after the event may help establish the conditions present when the icing event was initiated (i.e., when the actual output first deviated from the predicted value). Consideration of this data leads to a more accurate assessment of icing events, more accurate assignment of numerical icing event indicators in the data sets, and/or improved predictability of the regression model.

The present logistic regression function may be based on regression of any number of icing and/or non-icing events, preferably on at least about 200, more preferably about 400, still more preferably at least about 600 events, with at least about 800 events being even more preferred. These events may include any combination of icing and non-icing events. However, it is preferable to employ a substantial number of data sets for both icing and non-icing events in the model to improve the confidence that may be attributed to the model.

The input data for the regression model include two or more data sets from each of the at least one first wind turbines; each data set taken at a different point in time; each data set comprising input measurements of wind speed, temperature, and relative humidity conditions, each input being measured in proximity to the at least one first wind turbine; said input data for each data set further including an indication as to whether ice was present or absent on one or more blades of the at least one first wind turbine at said point in time.

In some preferred embodiments, the % of icing events relative to the total number of events in the model is from about 2% to about 30%, more preferably from about 4 to about 25%, still more preferably from about 6 to about 20% of the total number of events.

In certain preferred embodiments, the confidence attributed to model predictability is equal to or greater than about 75%, more preferably about 80%, still more preferably about 85%, with equal to or greater than about 95% being even more preferred. In still other preferred embodiments, the confidence level may approach, equal or exceed 98 or even 99%.

In some preferred embodiments of the present invention, the logistic regression function takes the form of the following mathematical expression:

$$Probability of Ice Event = \frac{{e}^{g}}{1 + {e}^{g}} ;$$

wherein the value of the variable “g” includes a constant and other values each of which is dependent on one of the local temperature, local wind speed and local % relative humidity.

As is generally understood by the ordinarily skilled artisan, logistic regression function typically have parameter limits associated with the prediction model. In some preferred embodiments of the present invention, the logistic regression function has parameter limits that include:

| | Lower Limit | Upper Limit |
|---|---|---|
| Temperature, ° C. | −6 | +1 |
| % Relative Humidity | 85% | 100% |
| Wind Speed (meters/sec) | 5 | 20 |

The lower limits and upper limits define conditions within which icing may or may not occur. Levels below or above those limits are characteristic of meteorological conditions wherein icing will not occur. The model is based, inter alia, on a premise that icing will not occur under meteorological conditions wherein the measured value of at least one of temperature, % relative humidity or wind speed, the conditions is less than the specified lower limit for that parameter; or wherein the measured value of at least one of temperature, % relative humidity or wind speed, the conditions exceeds that of the specified upper limit for that parameter, as hereindefined. By way of example, when the measured conditions include a relative humidity of 95%, a wind speed of 10 m/s and a temperature of +6° C., rain (rather than icing) is the predominant weather event (parameter limit that is exceeded in bold). By way of further example, when the measured conditions include a relative humidity of 95%, a wind speed of 10 m/s and a temperature of −10° C., snow is the predominant weather event (parameter limit that is exceeded in bold)

More preferably the value of the variable “g” may be expressed as follows:

g=−49.57+0.658 (Temperature C)+0.501 (Relative Humidity %)+0.632 (Wind Speed m/s.

In certain other preferred embodiments, the logistic regression function may be revised by acquiring data sets from additional ice events and/or non-events and regressing revised data table to provide a revised and/or further optimized logistic regression function.

In some preferred embodiments of the methods of the present invention, weather condition measurements are collected for one or more second wind turbines, each second input data comprising one or more second input data sets; each second data set taken at a different point in real time; each data set comprising input measurements of wind speed, temperature, and relative humidity conditions, each input measured in proximity to a second wind turbine. Each data set of weather condition measurements may then be entered into the logistic regression function to calculate a probability as to whether, subsequent to the real time measurements, ice is more or less likely to form on one or more blades of the second wind turbine.

In certain preferred embodiments, second data sets are collected for the one or more second wind turbines at pre-established time intervals on a continuing basis. Predicted probability for each of the one or more second turbines may then be optionally updated on a continuing basis as the data sets are fed, manually or automatically, preferably, automatically into the prediction model. Preferably, the time interval between data set collections is less than or equal to about 1 hour, more preferably 0.5 hours, still more preferably, 15 minutes, with less than or equal to about 10 minutes even more preferred.

In other preferred embodiments of the methods of the present invention, weather condition measurements are taken by sensors that feed the recorded data into a computer containing the prediction model, preferably feeding the data to the computer or its contained ice prediction model (of the present invention) on an on-going real time basis.

Certain of these embodiments have the added feature of an alarm or indicator which notifies operators or an automated wind turbine operation system of the potential for an icing event when the probability equals or exceeds a predetermined threshold value. This can lead to faster response times for pausing the one or more second turbines (or a turbine associated with said one or more second turbines) for a period of time, leading to a reduced level of icing or a prevention of further ice accretion, and may further minimize the time the wind turbine should be paused. In some preferred embodiments the one or more second wind turbines are paused for up to about 4 hours to reduce, halt, prevent icing accretion on or remove icing from a wind turbine blade.

Continued monitoring of local conditions may also facilitate a more rapid restart of the wind turbines after they have been paused by predicting when a substantial threat of icing based on weather conditions has passed. For example, once the model has predicted an icing event probability that equals or exceeds the predetermined threshold value, weather conditions at the site may be collected as subsequent data sets to the predicted event in real time. The model may be applied, as desired, to each subsequent data set or to any combination of the one or more subsequent data sets to ascertain whether the calculated probability associated with the subsequent data equals or exceeds the predetermined threshold value. Once the calculated probability associated with subsequent data in the one or more data sets falls below the predetermined threshold value, the wind turbine may be unpaused. In certain preferred embodiments, the calculated probability associated with subsequent data may fall below the predetermined threshold value in less than about 4 hours, more preferably 3, still more preferably less than about 2 hours. As is the case for pausing the turbines as described hereinabove, the unpausing may be manually carried out or done as part of an automated control system.

In some preferred embodiments, the predetermined threshold value is equal to or greater than about 0.85, more preferably 0.9, still more preferably about 0.93, yet more preferably about 0.95, with equal to or greater than about 0.97 being even more preferred.

The predetermined threshold value may be associated, in certain preferred embodiments, with particular groups of wind turbines. Grouping of wind turbines may be based on, for example, various weather conditions, susceptibility to icing events, and/or output parameters associated with a wind turbine. A grouping contemplated by the present invention may contain any of the possible combinations of wind turbines. For example, one group includes the following wind turbines: Vestas V47, Zond 750, Micon 750, GE 1.5 MW, GE 1.6 MW, Vestas V80, Micon 1.5 MW, Siemens 1.3 MW, Siemens 2.3 MW, and Clipper 2.5 MW turbines or any combination thereof; alternately independently preferred are each of the following alternative groupings of wind turbines: Vestas V47, Zond 750, and Micon 750 turbines or any combination thereof; or GE 1.5 MW, GE 1.6 MW, Vestas V80, Micon 1.5 MW, and Siemens 1.3 MW turbines or any combination thereof; or Siemens 2.3 MW and Clipper 2.5 MW turbines or any combination thereof.

In other preferred embodiments of the methods and/or models of the present invention, each first or second wind turbine is independently selected from the group consisting of: Vestas V47, Zond 750, Micon 750, GE 1.5 MW, GE 1.6 MW, Vestas V80, Micon 1.5 MW, Siemens 1.3 MW, Siemens 2.3 MW, and Clipper 2.5 MW turbines or any combination thereof.

In certain other more preferred embodiments of the methods and/or models of the present invention, each first or second wind turbine is independently selected from the group consisting of: Vestas V47, Zond 750, and Micon 750 turbines or any combination thereof. In some even more preferred embodiments each first or second wind turbine is independently selected from the group consisting of: Vestas V47, Zond 750, and Micon 750 turbines or any combination thereof, the predetermined threshold value associated with initiating a pause for any of these turbines is preferably a 90% Probability (0.9) of Icing.

In other more preferred embodiments of the methods and/or models of the present invention, each first or second wind turbine is independently selected from the group consisting of: GE 1.5 MW, GE 1.6 MW, Vestas V80, Micon 1.5 MW, and Siemens 1.3 MW turbines or any combination thereof. In some even more preferred embodiments each first or second wind turbine is independently selected from the group consisting of: Vestas V47, Zond 750, and Micon 750 turbines or any combination thereof, the predetermined threshold value associated with initiating a pause for any of these turbines is preferably a 93% Probability (0.93) of Icing.

In still other preferred embodiments of the methods and/or models of the present invention, each first or second wind turbine is independently selected from the group consisting of: Siemens 2.3 MW and Clipper 2.5 MW turbines or any combination thereof. In some even more preferred embodiments each first or second wind turbine is independently selected from the group consisting of: Vestas V47, Zond 750, and Micon 750 turbines or any combination thereof, the predetermined threshold value associated with initiating a pause for any of these turbines is preferably a 97% Probability (0.97) of Icing.

### EXPERIMENTAL SECTION

The tables provided below summarize the model from a statistical perspective through a listing of outputs for a preferred embodiment of the present invention. The strength of the model is noted in the Logistic Regression Table, which shows the highly significant P-Values (P<0.0001) for all parameters associated with this embodiment of the model. Goodness-of-Fit tests are also provided demonstrating excellent model robustness; all three tests show non-significant P-Values.

TABLE 1
Statistical Summary for a Binary Logistic Regression Model Directed to
Predicting Ice Blade Accretion
Probability of Ice Accretion = Temperature + Humidity + Wind Speed
Link Function: Logit

| Variable | Value | Count |
|---|---|---|
| Response | 1 | 167 |
| | 0 | 738 |
| | Total | 905 |

Logistic Regression Table:

| Predictor | Coefficient | SE Coefficient | Z | P-Value |
|---|---|---|---|---|
| Constant | −49.57 | 6.049 | −8.20 | <0.0001 |
| Temperature (C.) | 0.658 | 0.109 | 6.00 | <0.0001 |
| Humidity (%) | 0.501 | 0.061 | 8.13 | <0.0001 |
| Wind Speed (m/s) | 0.732 | 0.095 | 7.68 | <0.0001 |

Test that all slopes are zero:

| | | |
|---|---|---|
| G = 631.829 | DF = 3 | P-Value = <0.0001 |

Goodness-of-Fit Tests:

| Method | Chi-Square | DF | P-Value |
|---|---|---|---|
| Pearson | 277.91 | 711 | 1.000 |
| Deviance | 178.90 | 711 | 1.000 |
| Hosmer-Lemeshow | 3.06 | 8 | 0.930 |

When ranges are used herein for physical measurements, such as temperature, wind velocity, relative humidity, or time, or data sets, or numbers of events included in the model, or percentages of certain events relative to total number of events, or values calculated using the logistic regression functions of the present invention, such as predicted probabilities, confidence levels, or predetermined threshold values, or types of wind turbines, all combinations and subcombinations of ranges, values, and/or specific embodiments therein are intended to be included.

The disclosures of each patent, patent application and publication cited or described in this document are hereby incorporated herein by reference, in their entirety.

The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A method of predicting the probability of ice formation on one or more wind turbine blades, comprising:
(a) applying an ice prediction model employing a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time;
said regression function for determining a probability that icing will occur under a particular set of wind speed, temperature and relative humidity conditions;
(b) collecting second input data for one or more second wind turbines, each second input data comprising one or more second input data sets; each second data set taken at a different point in real time; each data set comprising input measurements of wind speed, temperature, and relative humidity conditions, each input measured in proximity to a second wind turbine; and
(c) calculating a probability as to whether, subsequent to the real time measurements, ice will form on one or more blades of the second wind turbine.

2. A method of claim 1, wherein the prediction model input data further comprises wind turbine rotor speed.

3. A method of claim 1, wherein the prediction model input data further comprises wind turbine blade dimensions.

4. A method of claim 1, wherein the presence of ice on the one or more blades of the at least one first wind turbine at said point in time in each prediction model data set is given a numerical value of 1 and the absence of ice is given a numerical value of 0.

5. A method of claim 1, wherein the calculated probability has at least about an 80% confidence level.

6. A method of claim 5, wherein the calculated probability has at least about a 95% confidence level.

7. A method of claim 1, wherein actual power output at a point in time is compared to theoretical power output based on the measured wind speed at said point in time to determine whether ice is present or absent on the one or more blades of the at least one first wind turbine at said point in time.

8. A method of claim 1, wherein the one or more second wind turbines are paused for a period of time if the calculated probability of ice formation equals or exceeds a predetermined threshold value.

9. A method of claim 8, wherein the one or more second wind turbines are paused for up to about 4 hours.

10. A method of claim 9, wherein the one or more second wind turbines are unpaused if a calculated probability based on one or more subsequent second data sets falls below the predetermined threshold value.

11. A method of claim 10, wherein the one or more second wind turbines are unpaused in less than about 4 hours.

12. A method of claim 8 or 10, wherein the threshold value for the probability is at least about 0.85.

13. A method of claim 8 or 10, wherein the second wind turbine is selected from the group consisting of: Vestas V47, Zond 750, Micon 750, GE 1.5 MW, GE 1.6 MW, Vestas V80, Micon 1.5 MW, Siemens 1.3 MW, Siemens 2.3 MW, and Clipper 2.5 MW.

14. A method of claim 13, wherein the predetermined threshold value is about 0.9 for the second wind turbine.

15. A method of claim 14, wherein the second wind turbine is selected from the group consisting of: Vestas V47, Zond 750, and Micon 750.

16. A method of claim 13, wherein the predetermined threshold value is about 0.93 for the second wind turbine.

17. A method of claim 16, wherein the second wind turbine is selected from the group consisting of: GE 1.5 MW, GE 1.6 MW, Vestas V80, Micon 1.5 MW, and Siemens 1.3 MW.

18. A method of claim 13, wherein the predetermined threshold value is about 0.97 for the second wind turbine.

19. A method of claim 18, wherein the second wind turbine is selected from the group consisting of: Siemens 2.3 MW and Clipper 2.5 MW.

20. A method of claim 1, wherein the second data set inputs are transmitted from sensors to a computer containing the wind turbine blade ice prediction model.

21. An ice prediction model comprising:
a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time; and
said regression function for determining a probability that icing will occur under a particular set of wind speed, temperature and relative humidity conditions.

22. An ice prediction model of claim 21, wherein the regression function further comprising the following formula:
$$Probability of Ice Event = \frac{{e}^{g}}{1 + {e}^{g}} .$$
wherein g=−49.57+0.658 (Temperature C)+0.501 (Relative Humidity %)+0.632 (Wind Speed m/s.

23. A method of claim 1, wherein the regression function further comprising the following formula:
$$Probability of Ice Event = \frac{{e}^{g}}{1 + {e}^{g}} ;$$
wherein g=−49.57+0.658 (Temperature C)+0.501 (Relative Humidity %)+0.632 (Wind Speed m/s.

24. A method of predicting the output or operation of a wind turbine at a wind farm site considered for new construction or acquisition, comprising:
(a) applying an ice prediction model employing a logistic regression function, said function comprising input data of at least one first wind turbine;
said input data including two or more data sets from each of the at least one first wind turbines; each data set taken at a different point in time; each data set comprising input measurements of wind speed, temperature, and relative humidity conditions, each input being measured in proximity to the at least one first wind turbine;
said input data for each data set further including an indication as to whether ice was present or absent on one or more blades of the at least one first wind turbine at said point in time;
said regression function for determining a probability that icing will occur under a particular set of wind speed, temperature and relative humidity conditions;
(b) collecting historical weather condition data from one or more weather monitoring stations in proximity to the wind farm site considered for new construction or acquisition, each historical weather condition input data comprising one or more second input data sets; each second data set taken at a different point in recorded time; each data set comprising input measurements of wind speed, temperature, and relative humidity conditions, each input measured in proximity to the wind farm site considered for new construction or acquisition; and
(c) calculating a probability as to whether, subsequent to the recorded time measurements, ice would have formed on one or more blades of a second wind turbine;
(d) calculating the duration of an ice event based on the probability that ice would have formed on one or more blades of the second wind turbine; and
(e) estimating loss of output from the second wind turbine based on the duration of the ice event.
